(19) United States
(12) Patent Application Publication
(10) Pub. No.: US 2007/0239574 A1
(43) Pub. Date: Oct. 11, 2007

(54) System and method for real estate transactions

(76) Inventors: Michael B. Marlow, Houston, TX (US); Mark Marlow, Houston, TX (US)

Correspondence Address: THE MATTHEWS FIRM, 2000 BERING DRIVE, SUITE 700, HOUSTON, TX, 77057, US

(21) Appl. No.: 11/399,749

(22) Filed: Apr. 7, 2006

(51) Int. Cl. G06Q 40/00

(52) U.S. Cl. 705/35; 705/38

(57) ABSTRACT

A method and system for real estate transactions concerning the purchase or sale of real property is provided. The method comprises engaging a realtor and a mortgage originator to participate in the real estate transaction, providing unified communication among a client, the realtor and the mortgage originator, whereby the mortgage originator may be the realtor, providing a simplified loan process for the client by the coordination between the realtor and the mortgage originator due to the unified communication among the client, the realtor and the mortgage originator, upon the sale of property, distributing to the client, from the real estate commission received by the realtor, a predetermined portion of money from the purchase price, the loan amount and the listing fee, then, distributing to the realtor a portion of the mortgage origination proceeds typically received by the mortgage originator to compensate for the portion of the purchase price, loan amount and listing fee distributed to the client, and, upon the purchase of property, distributing to the client, from the real estate commission received by the realtor, a predetermined portion of money from the purchase price, the loan amount and the listing fee, then, distributing to the realtor a portion of the mortgage origination proceeds typically received by the mortgage originator to compensate for the portion of the purchase price, loan amount and listing fee distributed to the client, such that, upon a sale, a purchase, and any combination of sales and purchases, the client receives a predetermined portion of money from the purchase price of the property, the loan amount and the listing fee, the realtor receives the full amount of the predetermined real estate commission for the sale consummated and the mortgage originator receives a proportionately smaller portion of the mortgage origination proceeds.

### FIELD OF THE INVENTION

The present invention relates generally to a system and method for real estate transactions. Specifically, the present invention relates to a system and method for the sale of property where the seller/buyer's agent (the realtor), the mortgage originator and the buyer coordinate the sale of the property such that all three, or a combination thereof, maximize the returns received with respect to the sale of the property.

### BACKGROUND OF THE INVENTION

The real estate market, residential and commercial, functions in an archaic manor that has gone essentially unchanged over time. The archaic state of the real estate market is true for several reasons. First, real estate, especially residential real estate, is being bought and sold according to a decades old paradigm. The primary players in the industry are the seller/buyer's agents, i.e., realtors, the loan officers, mortgage originators and title companies. These entities are fairly conservative, somewhat technically unsophisticated, and generally reluctant to embrace change. The characteristics embodied by the primary players results in a process which, for many home sellers and buyers, is shrouded in mystery, appearing arcane and convoluted, not to mention inefficient, inconvenient and expensive.

Typically, one of the most complex and significant financial events in most people's lives is the purchase or sale of a home or investment property. Because of this complexity and significance, people typically seek the help of real estate brokers, sales agents, loan officers and mortgage originators when buying or selling real estate.

Real estate brokers and sales agents are familiar with local zoning and tax laws and, most importantly, know where to obtain financing. Real estate agents usually are independent sales workers who provide their services to a licensed real estate broker on a contract basis. In return, the broker pays the agent a portion of the commission earned from the agent's sale of the property. Brokers are independent businesspeople who sell real estate owned by others; they also may rent or manage properties for a fee. When selling real estate, brokers or agents arrange for title searches and for meetings between buyers and sellers during which the details of the transactions are agreed upon and the new owners take possession of the property. A broker or agent may help to arrange favorable financing from a mortgage originator or lender for the prospective buyer; often, this makes the difference between success and failure in closing a sale. In some cases, brokers and agents assume primary responsibility for closing sales; in others, lawyers or lenders do. Brokers supervise agents who may have many of the same job duties. Brokers also supervise their own offices, advertise properties, and handle other business matters. Some combine other types of work, such as selling insurance or practicing law, with their real estate business.

Besides making sales, agents and brokers must have properties to sell. Consequently, they spend a significant amount of time obtaining listings or agreements by owners to place properties for sale with the firm. When listing a property for sale, agents and brokers compare the listed property with similar properties that recently sold, in order to determine a competitive market price for the property. Once the property is sold, both the agent who sold it and the agent who obtained the listing receive a portion of the commission. Thus, agents who sell a property that they themselves have listed can increase their commission.

Most real estate brokers and sales agents sell residential property. A small number which are usually employed in large or specialized firms sell commercial, industrial, agricultural or other types of real estate. Every specialty requires knowledge of that particular type of property and clientele. Selling or leasing business property requires an understanding of leasing practices, business trends, and the location of the property. Agents who sell or lease industrial properties must know about the region's transportation, utilities, and labor supply. Whatever the type of property, the agent or broker must know how to meet the client's particular requirements, and meeting these needs is critical to making a sale.

Before showing residential properties to potential buyers, agents meet with them to get a feeling for the type of home the buyers would like. In this prequalifying phase, the agent determines how much the buyers can afford to spend. In addition, the agent and the buyer usually sign a loyalty contract which states that the agent will be the only one to show houses to buyers. An agent or broker then generates lists of properties for sale, their location and description, and available sources of financing. In some cases, agents and brokers use computers to give buyers a virtual tour of properties in which they are interested. With a computer, buyers can view interior and exterior images or floor plans without leaving the real estate office.

Agents may meet several times with prospective buyers to discuss and visit available properties. Agents identify and emphasize the most pertinent selling points. To a young family looking for a house, they may emphasize the convenient floor plan, the area's low crime rate and the proximity to schools and shopping centers. To a potential investor, they may point out the tax advantages of owning a rental property and the ease of finding a renter. If bargaining over price becomes necessary, agents must follow their client's instructions carefully and may have to present counteroffers in order to get the best possible price.

Once both parties have signed the contract, the real estate broker or agent must make sure that all special terms of the contract are met before the closing date. For example, the agent must make sure that the mandated and agreed-upon inspections, including that of the home and termite and radon inspections, take place. Also, if the seller agrees to any repairs, the broker or agent must see that they are made. Increasingly, brokers and agents are handling environmental problems as well, by making sure that the properties they sell meet environmental regulations. For example, they may be responsible for dealing with lead paint on the walls. While loan officers, attorneys, mortgage originators or other persons handle many details, the agent must ensure that they are carried out.

The loan officer or loan agent in conjunction with the mortgage originator or mortgage loan broker help clients locate money to borrow and assist them with many objectives including filing-out the required loan application and the additional paperwork necessary in order to process the loan.

Today, most loan officers or loan agents work with a mortgage company. Their attraction is that they provide their loan officers and loan agents with a greater array of money sources through various private and institutional lenders. This allows a loan officer or loan agent to qualify more borrowers. By being better able to meet the needs of a greater number of prospective clients this helps their agents develop a more lucrative career and provides the company with a greater income.

Loan officers and agents facilitate the lending by seeking potential clients and assisting them in applying for various types of loans. Loan officers and agents also gather information about clients and businesses to ensure that an informed decision is made regarding the quality of the loan and the probability of repayment. In many instances, loan officers or agents act as salespeople.

Commercial loan officers, as an example, one working for a bank, may contact firms to determine their needs for loans. If a firm is seeking new funds, the loan officer will try to persuade the company to obtain the loan from their institution. Similarly, mortgage loan officers or agents, those representing various lenders, develop relationships with commercial and residential real estate companies so that, when an individual or firm buys a property, the real estate agent might recommend them to handle the clients financing needs. Once this initial contact has been made, loan officers guide clients through the process of applying for a loan.

The loan process begins with a formal meeting or telephone call with a real estate agent or a prospective client, during which the mortgage loan agent obtains basic information about the purpose of the loan and explains the different types of loans and credit terms that are available to the applicant. Loan agents answer questions about the process and sometimes assist clients in filling-out the required application. After a client completes the application, the loan agent begins the process of analyzing and verifying the application to determine the client's credit worthiness. Often, loan agents can quickly access the client's credit history by computer and obtain a credit score. This score represents the credit worthiness of a person or business as assigned by a software program that makes the evaluation. In cases where a credit history is not available or where unusual financial circumstances are present, the loan agent may request additional financial information from the client or, in the case of commercial loans, copies of the company's financial statements. With this information, loan officers who specialize in evaluating a client's credit worthiness, who are usually working for the lender of the funds, would be asked to conduct a financial analysis or other risk assessment of the potential client. This additional information would be included as written comments in the client's loan file, which is used to analyze whether the prospective loan meets the lending institution's requirements.

The lender or the source of the money, once receiving the loan package would in consultation with their managers, decide whether or not to grant or approve the loan. If the loan is approved, a repayment schedule is arranged with the client. A loan may be approved that would otherwise be denied if, for example, the customer can provide the lender with appropriate collateral-property pledged as security for the repayment of a loan.

A loan officer r agent earns a commission on a completed loan that can be as little $500 to as much as $10,000 or more depending on the loan amount and points or loan fee charged.

In comparison, the job descriptions of the real estate agent and the loan officer have overlapping functions, from what each must do in performing his or her job to how they get paid for what they have done.

Thus, there is a high level of complexity associated with any real estate transaction. And, essentially any real estate transaction is a challenging endeavor. In order to facilitate a residential real estate transaction from beginning to end, the conservative players in the industry must work together. However, in most situations, the primary players in the real estate market are forced to act against their own perceived interests in consummating any real estate transaction. The interaction between the primary players, real estate agents or realtors, loan officers, mortgage originators and title companies, make the home selling and buying process practically unintelligible to the typical home sellers and buyers.

For example, when someone wants to buy a home under the current paradigm, not only must they spend inordinate amounts of time attending open houses and meeting with their real estate agent, they must also meet and communicate with the loan officer, lending institutions, title companies, and escrow officers. As the number of players in the purchase and sale of property increases, the inconveniences and frustration of the potential buyer is exacerbated. In short, despite the rapid advancement of technology in many areas of commerce, buying or selling a home today can be a very frustrating, inefficient, and time consuming process.

There have been attempts to modernize the process. Information technology is sometimes used in the process in a peripheral sense, but is not central to the typical residential real estate transaction. For example, some real estate agents have an online presence, using web sites for providing information to prospective buyers and sellers. Online automation of the loan brokering process is also currently available. However, none of the automated real estate efforts do more than facilitate one or more of the many steps in buying or selling a home. That is, no known real estate effort can rectify the built-in, inherent competitive nature of the primary players in the industry, i.e., the realtors, the mortgage brokers and the title companies. And, the built-in, inherent competitive nature of the primary players in the real estate industry results in a situation that is vague, ambiguous and costly to the buyer or seller. The process is time consuming and inefficient. And in many situations, the real estate system is a system that is adverse to the very entity that it was designed to help, the buyer.

It is, therefore, a feature of the present invention to provide a system and method for real estate transactions that results in the buyer receiving clear communication from the primary market entities, a simplified loan process and substantial savings.

A feature of the present invention is to provide a system and method for real estate transactions that results in the selling agent receiving 100% of any predetermined commission.

Another feature of the present invention is to provide a system and method for real estate transactions that results in the selling agent not having any desk fees, monthly fees or transaction fees.

Another feature of the present invention is to provide a system and method for real estate transactions that results in competitive commission splits for all transactions regardless of who originates the loan.

Another feature of the present invention is to provide a system and method for real estate transactions that results in the buyer receiving reliable communications regarding the mortgage loan application and closing process.

Yet another feature of the invention is to provide a system and method for real estate transactions that creates a full service agent.

Still another feature of the present invention is utilizing a system and method for real estate transactions such that a full service agent can compete in a growing discount realty market without cutting fees.

Another feature of the present invention is to provide a system and method for real estate transactions such that a full service agent can compete without being priced out of a transaction when competing with traditional full service companies.

Yet another feature of the present invention is to provide a system and method for real estate transactions such that an agent can supplement income with non-sales related loans.

Still another feature of the present invention is to provide a system and method for real estate transactions such that an agent takes the mortgage application, and where appropriate, educates the buyer/borrower in the home buying and financing process, orders inspections, maintains regular contact with the buyer and the lender, determines whether the property is in the flood zone, participates in the closing, collects financial information concerning the transaction, initiates ordering appraisals.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein, methods and systems for real estate transactions are provided. The methods and systems for real estate transactions concern the purchase or sale of real property in association with a selling agent that receives a commission for any sale consummated and a mortgage originator that receives a portion of the mortgage origination proceeds.

A method of the present invention comprises the steps of engaging the realtor to assist in the real estate transaction, engaging the mortgage originator to assist in the real estate transaction, and providing unified communication among the buyer, the realtor and the mortgage originator. Thus, a simplified loan process is provided for the buyer by the coordination between the realtor and the mortgage originator due to the unified communication among the buyer, the realtor and the mortgage originator. The buyer receives, from the real estate commission received by the realtor, a predetermined portion of money from either the purchase price of the property or the loan amount. The realtor receives a portion of the mortgage origination proceeds typically received by the mortgage originator to compensate for the portion of the purchase price of the property and loan amount distributed to the buyer from the real estate commission received by the realtor. Therefore, in using this method of the present invention, the buyer receives a predetermined portion of money from the purchase price of the property and/or the loan amount, the realtor receives the full amount of the predetermined real estate commission for the sale he or she made and the mortgage originator receives a proportionately smaller portion of the mortgage origination proceeds.

Another method of the present invention comprises the steps of engaging the realtor to participate in the real estate transaction, engaging the mortgage originator to participate in the real estate transaction, providing unified communication among the client, the realtor and the mortgage originator, whereby the mortgage originator may be the realtor. Thus, a simplified loan process is created for the client by the coordination between the realtor and the mortgage originator due to the unified communication among the client, the realtor and the mortgage originator. Upon the sale of property, the client receives, from the real estate commission received by the realtor, a predetermined portion of money from the purchase price, the loan amount and/or the listing fee. Then, the realtor receives a portion of the mortgage origination proceeds typically received by the mortgage originator to compensate for the portion of the purchase price, loan amount and/or listing fee distributed to the client from the real estate commission received by the realtor. Similarly, upon the purchase of property, the client receives, from the real estate commission received by the realtor, a predetermined portion of money from the purchase price, the loan amount and/or the listing fee. Then, the realtor receives a portion of the mortgage origination proceeds typically received by the mortgage originator to compensate for the portion of the purchase price, loan amount and/or listing fee distributed to the client from the real estate commission received by the realtor. Therefore, upon a sale, a purchase, and any combination of sales and purchases, the client receives a predetermined portion of money from the purchase price of the property, the loan amount and/or the listing fee, the realtor receives the full amount of the predetermined real estate commission for the sale consummated and the mortgage originator receives a proportionately smaller portion of the mortgage origination proceeds.

In yet another method of the present invention the mortgage originator assists in the real estate transaction such that the mortgage originator acts in the capacity of a loan officer and the realtor as well as the mortgage originator thereby eliminating the conventional use of the loan officer and the realtor. The mortgage originator, to the exclusion of the typical loan officer and realtor, provides a unified communication between the client and the mortgage originator such that the mortgage originator is guided to secure better mortgage terms for the client. Further, the method provides a simplified loan process for the client because of the unified communication between the client and the mortgage originator. Upon the sale of property, the client receives, from the real estate commission typically received by the realtor, a predetermined portion of money from the purchase price, the loan amount and the listing fee. And, upon the purchase of property, the client receives, from the real estate commission typically received by the realtor, a predetermined portion of money from the purchase price, the loan amount and/or the listing fee. Therefore, upon the sale of property, the purchase of property, and any combination of sales and purchases, the client receives a predetermined portion of money from the purchase price of the property, the loan amount and/or the listing fee, and the mortgage originator receives a proportionately smaller portion of the mortgage origination proceeds.

The system of the present invention comprises the realtor being engaged to assist in the real estate transaction and the mortgage originator being engaged to assist in the real estate transaction to the exclusion of the typical loan officer. The mortgage originator is in unified communication with the client and the realtor such that the mortgage originator is guided to secure better mortgage terms for the client. The unified communication between the client, the realtor and the mortgage originator, without the loan officer, enhances the opportunity to achieve the best possible mortgage terms for the client. A simplified loan process is created for the buyer because of the unified communication between the client, the realtor and the mortgage originator, without the loan officer. Such that, upon the sale of property, the client receives, from the real estate commission received by the realtor, a predetermined portion of money from the purchase price, the loan amount and/or the listing fee; then, the realtor receives a portion of the mortgage origination proceeds typically received by the mortgage originator to compensate for the portion of the purchase price, loan amount and/or listing fee distributed to the client from the real estate commission received by the realtor. And, upon the purchase of property, the client receives, from the real estate commission received by the realtor, a predetermined portion of money from the purchase price, the loan amount and/or the listing fee; then, the realtor receives a portion of the mortgage origination proceeds typically received by the mortgage originator to compensate for the portion of the purchase price, loan amount and/or listing fee distributed to the client from the real estate commission received by the realtor. Therefore, upon a sale, a purchase, and any combination of sales and purchases, the client receives a predetermined portion of money from the purchase price of the property, the loan amount and/or the listing fee, the realtor receives the full amount of the predetermined real estate commission for the sale consummated and the mortgage originator receives a proportionately smaller portion of the mortgage origination proceeds.

In another system of the present invention, the mortgage originator is engaged to assist in the real estate transaction such that the mortgage originator acts in the capacity of a loan officer and the realtor as well as the mortgage originator, thereby, eliminating the conventional use of the loan officer and the realtor. The mortgage originator is in unified communication with the client such that the mortgage originator is guided to secure better mortgage terms for the client. The unified communication between the client and the mortgage originator, without the loan officer and the realtor, enhances the opportunity to achieve the best possible mortgage terms for the client. Thus, a simplified loan process is created for the buyer because of the unified communication between the client and the mortgage originator. Upon the sale of property, the client receives, from the real estate commission typically received by the realtor, a predetermined portion of money from the purchase price, the loan amount and/or the listing fee. And, upon the purchase of property, the client receives, from the real estate commission typically received by the realtor, a predetermined portion of money from the purchase price, the loan amount and/or the listing fee. Therefore, upon the sale of property, the purchase of property, and/or any combination of sales and purchases, the client receives a predetermined portion of money from the purchase price of the property, the loan amount and the listing fee and the mortgage originator receives a proportionately smaller portion of the mortgage origination proceeds.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a flow chart of a preferred embodiment of a method for real estate transactions concerning the purchase or sale of real property encompassed by the present invention.

FIG. 2 is a flow chart of another preferred embodiment of a method for real estate transactions concerning the purchase or sale of real property encompassed by the present invention.

FIG. 3 is a flow chart of yet another preferred embodiment of a method for real estate transactions concerning the purchase or sale of real property encompassed by the present invention.

FIG. 4 is a flow chart of a preferred embodiment of a system for real estate transactions concerning the purchase or sale of real property encompassed by the present invention.

FIG. 5 is a flow chart of another preferred embodiment of a system for real estate transactions concerning the purchase or sale of real property encompassed by the present invention.

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

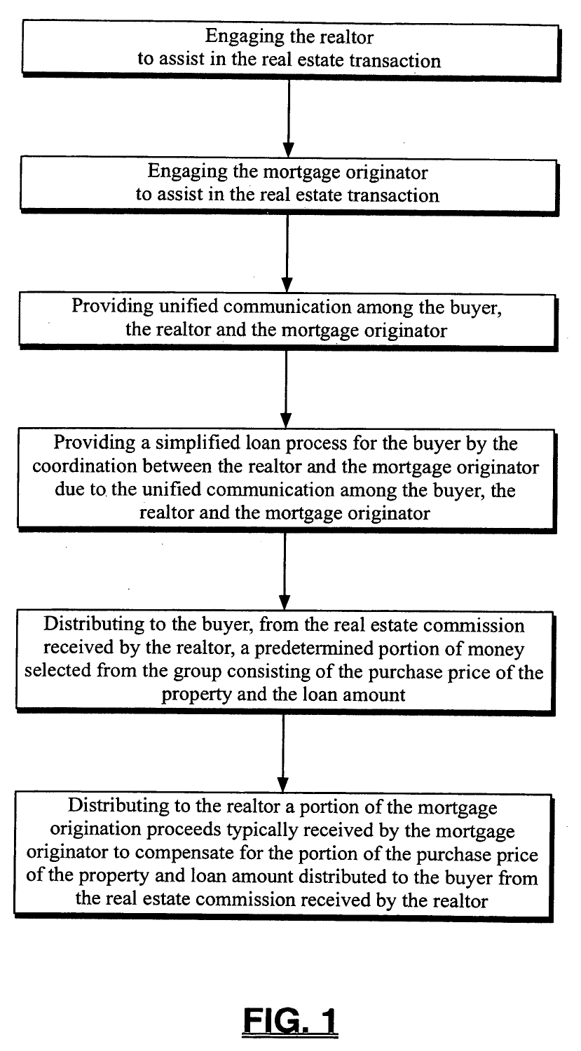

FIG. 1 is a flow chart of a preferred embodiment of a method for real estate transactions concerning the purchase or sale of real property encompassed by the present invention.

The method for real estate transactions in FIG. 1 concerns the purchase or sale of real property in association with a buyer, a realtor that receives a predetermined real estate commission for any sale consummated and a mortgage originator that receives a portion of the mortgage origination proceeds. The method comprises the steps of engaging the realtor to assist in the real estate transaction, engaging the mortgage originator to assist in the real estate transaction, and providing unified communication among the buyer, the realtor and the mortgage originator. Thus, a simplified loan process is provided for the buyer by the coordination between the realtor and the mortgage originator due to the unified communication among the buyer, the realtor and the mortgage originator. The buyer receives, from the real estate commission received by the realtor, a predetermined portion of money from the purchase price of the property and the loan amount. The realtor receives a portion of the mortgage origination proceeds typically received by the mortgage originator to compensate for the portion of the purchase price of the property and loan amount distributed to the buyer from the real estate commission received by the realtor. Therefore, in using the method of the present invention, the buyer receives a predetermined portion of money from the purchase price of the property and/or the loan amount, the realtor receives the full amount of the predetermined real estate commission for the sale he or she made and the mortgage originator receives a proportionately smaller portion of the mortgage origination proceeds.

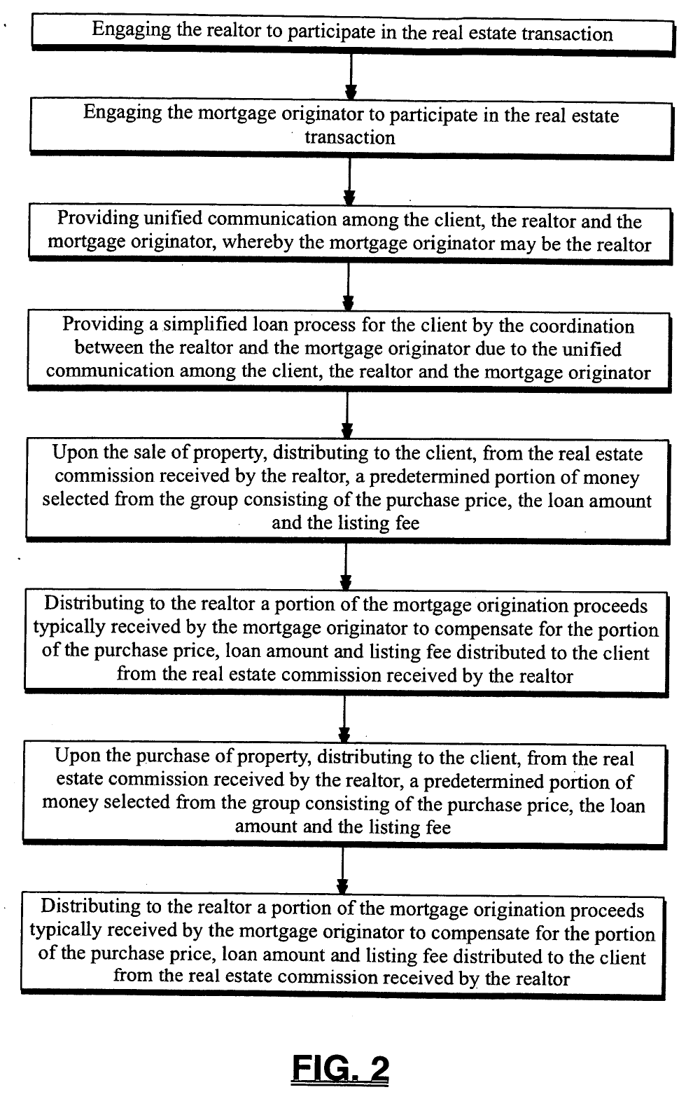

FIG. 2 is a flow chart of another preferred embodiment of a method for real estate transactions concerning the purchase or sale of real property encompassed by the present invention. The method for real estate transactions in FIG. 2 concerns the purchase or sale of real property in association with a client that can be a seller and/or a buyer, a realtor that receives a predetermined real estate commission for any sale made and a mortgage originator that receives a portion of the mortgage origination proceeds. The method comprises the steps of engaging the realtor to participate in the real estate transaction, engaging the mortgage originator to participate in the real estate transaction, providing unified communication among the client, the realtor and the mortgage originator, whereby the mortgage originator may be the realtor. Thus, a simplified loan process is created for the client by the coordination between the realtor and the mortgage originator due to the unified communication among the client, the realtor and the mortgage originator.

Upon the sale of property, the client receives, from the real estate commission received by the realtor, a predetermined portion of money from the purchase price, the loan amount and the listing fee. Then, the realtor receives a portion of the mortgage origination proceeds typically received by the mortgage originator to compensate for the portion of the purchase price, loan amount and/or listing fee distributed to the client from the real estate commission received by the realtor. Similarly, upon the purchase of property, the client receives, from the real estate commission received by the realtor, a predetermined portion of money from the purchase price, the loan amount and/or the listing fee. Then, the realtor receives a portion of the mortgage origination proceeds typically received by the mortgage originator to compensate for the portion of the purchase price, loan amount and listing fee distributed to the client from the real estate commission received by the realtor. Therefore, upon a sale, a purchase, and any combination of sales and purchases, the client receives a predetermined portion of money from the purchase price of the property, the loan amount and/or the listing fee, the realtor receives the full amount of the predetermined real estate commission for the sale consummated and the mortgage originator receives a proportionately smaller portion of the mortgage origination proceeds.

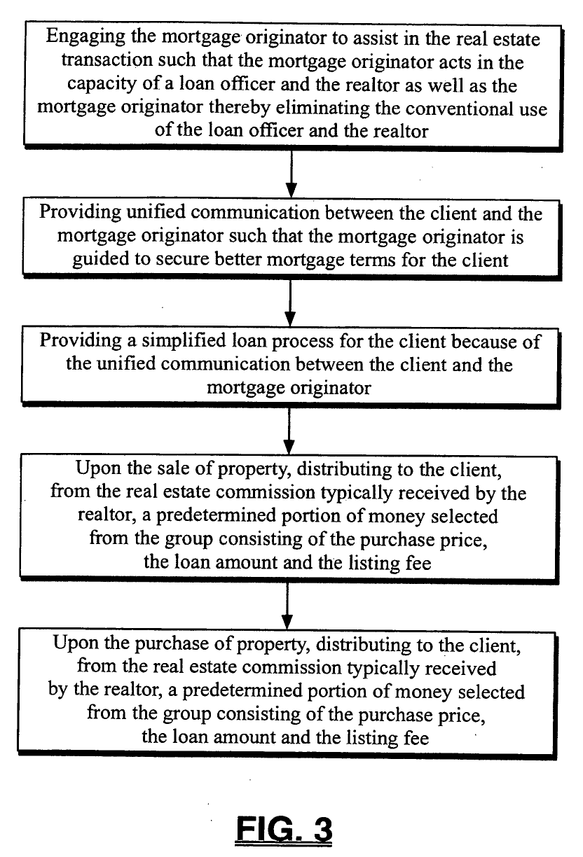

FIG. 3 is a flow chart of yet another preferred embodiment of a method for real estate transactions concerning the purchase or sale of real property encompassed by the present invention.

The method for real estate transactions illustrated in FIG. 3 concerns the purchase or sale of real property in association with a client that can be a seller and/or a buyer, a realtor that receives a predetermined real estate commission for any sale consummated and a mortgage originator that receives a portion of the mortgage origination proceeds. The method comprises engaging the mortgage originator to assist in the real estate transaction such that the mortgage originator acts in the capacity of a loan officer and the realtor as well as the mortgage originator thereby eliminating the conventional use of the loan officer and the realtor. Providing unified communication between the client and the mortgage originator such that the mortgage originator is guided to secure better mortgage terms for the client. Further, providing a simplified loan process for the client because of the unified communication between the client and the mortgage originator. Upon the sale of property, the client receives, from the real estate commission typically received by the realtor, a predetermined portion of money selected from the group consisting of the purchase price, the loan amount and the listing fee. And, upon the purchase of property, the client receives, from the real estate commission typically received by the realtor, a predetermined portion of money from the purchase price, the loan amount and/or the listing fee. Therefore, upon the sale of property, the purchase of property, and any combination of sales and purchases, the client receives a predetermined portion of money from the purchase price of the property, the loan amount and the listing fee and the mortgage originator receives a proportionately smaller portion of the mortgage origination proceeds.

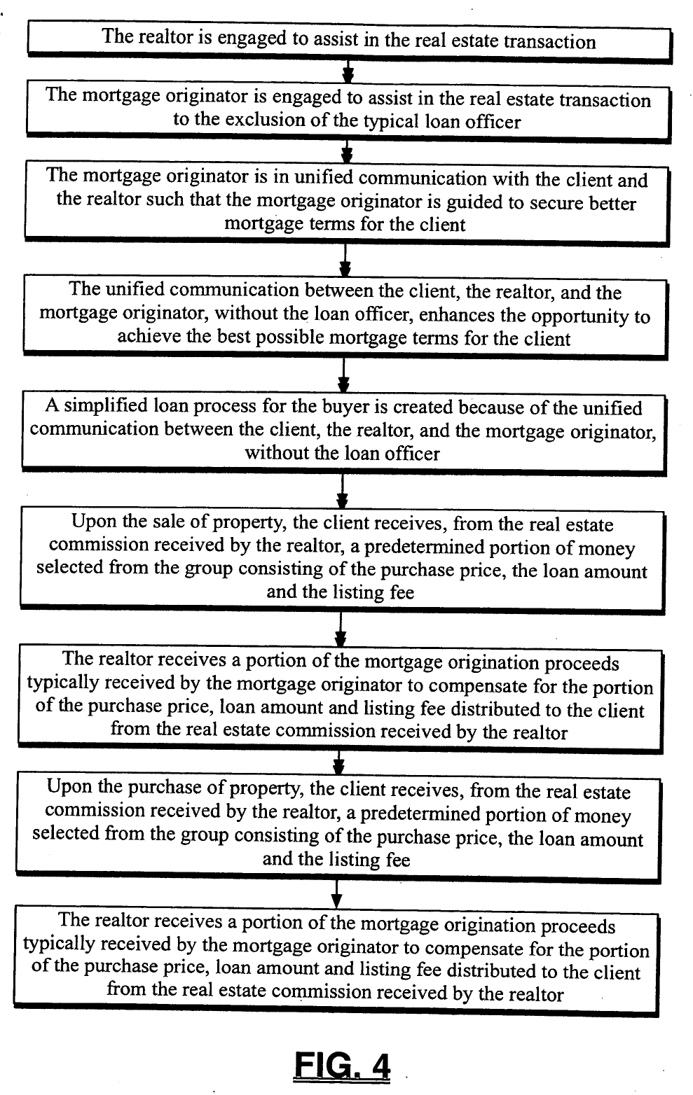

FIG. 4 is a flow chart of a preferred embodiment of a system for real estate transactions concerning the purchase or sale of real property encompassed by the present invention.

The system for conducting real estate transactions illustrated in FIG. 4 addresses the purchase or sale of real property in association with a client that can be a seller and/or a buyer, a realtor that receives a predetermined real estate commission for any sale consummated and a mortgage originator that receives a portion of the mortgage origination proceeds. The system comprises the realtor being engaged to assist in the real estate transaction and the mortgage originator being engaged to assist in the real estate transaction to the exclusion of the typical loan officer. The mortgage originator is in unified communication with the client and the realtor such that the mortgage originator is guided to secure better mortgage terms for the client. The unified communication between the client, the realtor, and the mortgage originator, without the loan officer, enhances the opportunity to achieve the best possible mortgage terms for the client. A simplified loan process for the buyer is created because of the unified communication between the client, the realtor, and the mortgage originator, without the loan officer. Such that, upon the sale of property, the client receives, from the real estate commission received by the realtor, a predetermined portion of money from the purchase price, the loan amount and/or the listing fee; then, the realtor receives a portion of the mortgage origination proceeds typically received by the mortgage originator to compensate for the portion of the purchase price, loan amount and/or listing fee distributed to the client from the real estate commission received by the realtor. And, upon the purchase of property, the client receives, from the real estate commission received by the realtor, a predetermined portion of money from the purchase price, the loan amount and/or the listing fee; then, the realtor receives a portion of the mortgage origination proceeds typically received by the mortgage originator to compensate for the portion of the purchase price, loan amount and/or listing fee distributed to the client from the real estate commission received by the realtor. Therefore, upon a sale, a purchase, and any combination of sales and purchases, the client receives a predetermined portion of money from the purchase price of the property, the loan amount and/or the listing fee, the realtor receives the full amount of the predetermined real estate commission for the sale consummated and the mortgage originator receives a proportionately smaller portion of the mortgage origination proceeds.

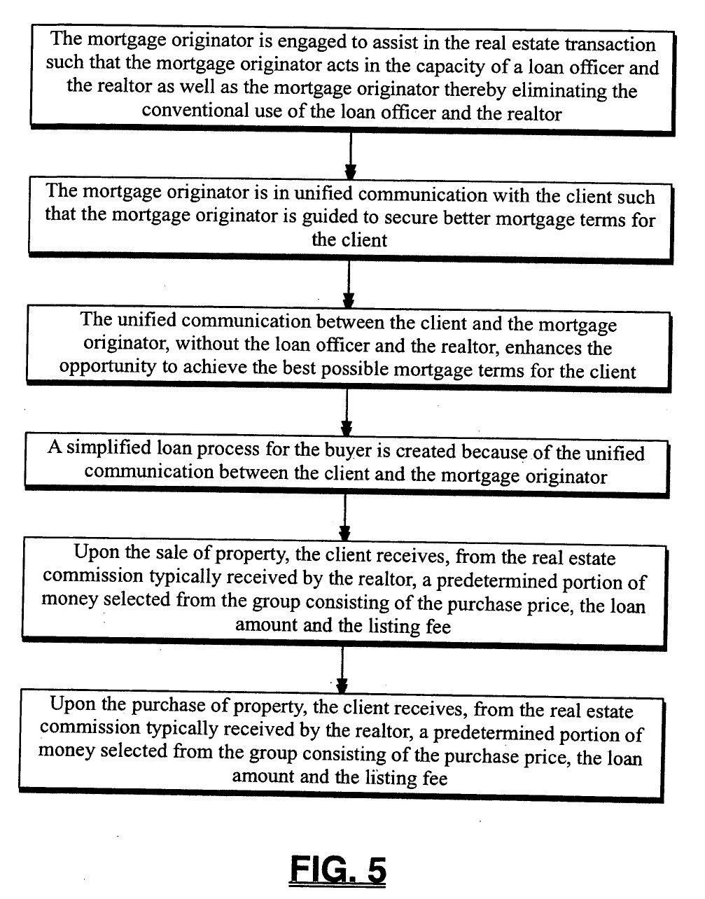

FIG. 5 is a flow chart of a preferred embodiment of a system for real estate transactions concerning the purchase or sale of real property encompassed by the present invention.

The system for conducting real estate transactions illustrated in FIG. 5 concerns the purchase or sale of real property in association with a client that can be a seller and a buyer, a realtor that receives a predetermined real estate commission for any sale consummated and a mortgage originator that receives a portion of the mortgage origination proceeds. The system comprises the mortgage originator being engaged to assist in the real estate transaction such that the mortgage originator acts in the capacity of a loan officer and the realtor as well as the mortgage originator thereby eliminating the conventional use of the loan officer and the realtor. The mortgage originator is in unified communication with the client such that the mortgage originator is guided to secure better mortgage terms for the client. The unified communication between the client and the mortgage originator, without the loan officer and the realtor, enhances the opportunity to achieve the best possible mortgage terms for the client. Thus, a simplified loan process is created for the buyer because of the unified communication between the client and the mortgage originator. Upon the sale of property, the client receives, from the real estate commission typically received by the realtor, a predetermined portion of money from the purchase price, the loan amount and/or the listing fee. And, upon the purchase of property, the client receives, from the real estate commission typically received by the realtor, a predetermined portion of money from the purchase price, the loan amount and/or the listing fee. Therefore, upon the sale of property, the purchase of property, and/or any combination of sales and purchases, the client receives a predetermined portion of money from the purchase price of the property, the loan amount and the listing fee and the mortgage originator receives a proportionately smaller portion of the mortgage origination proceeds.

### EXAMPLES

### Example 1

An agent has found her client a $150,000 home and the client originates the mortgage with the originator.
$150,000×3%=$4,500.

The agent receives $3,000 from the real estate commission.

Licensed agents also receive $1,500 of the mortgage origination proceeds. The client receives a $1,500.00 refund from the real estate commission portion of the transaction within 3-5 business days of funding.

### Example 2

An agent's client allows her to sell their house, represent them on purchase of their next home, and originates their mortgage.

The client sells a $100,000 house in which the commission is 6% and another company represents the buyer. You would receive $3,000. Of which, you would offer your client a $1,000 refund within 3-5 business days of funding on their next home.

The client then buys a $150,000 house and lets the originator originate their loan. Licensed agents would receive $3,000 from the real estate commission and $1,500 from the mortgage origination proceeds. Your client would receive another $1,500 refund within 3-5 business days of funding.

The agent would make $6,500 in this transaction.

The client would receive $2,500 in refunds.

Note: If the agent does not split the 6% commission in the original listing she would receive $9,500 in this transaction and her client would still receive $2,500 in refunds.

### Example 3

A client buys a $50,000 house that pays a 3% commission.

Originator does not originate a mortgage for the client.

Licensed agents would receive $750.00 ($50,000×3%=$1,500×50%).

The client buys a $100,000 home that pays a 3% commission.

Originator does not originate a mortgage for the client.

Licensed agent would receive $2,000 ($100,000×3%=$3,000=$1,000).

The client sells their $100,000 house and does not buy another home or originate a loan with Originator.

Licensed agent would receive $2,000 ($100,000×3%=$3,0000=$1,000).

### Example 4

A non-licensed agent has found his client a $150,000 home and they originate their mortgage with Originator.
$150,000×3%=$4,500.

The non-licensed agent receives $3,000 from the real estate commission.

The client will receive $1,500 from the real estate commission within 3-5 business days of funding.

### Example 5

A client allows a non-licensed agent to sell their house, represent them on the purchase of their next home, and originates their mortgage with Originator.

The client sells a $100,000 house in which the commission is 6% and another company or another agent represents the buyer. The agent would receive $3,000. Of which the agent would offer his client a $1,000 refund.

The client then buys a $150,000 house and lets Originator originate their loan. The agent would receive $3,000 from the real estate commission. The client would receive another $1,500 refund within 3-5 business days of funding.

The non-licensed agent would make $5,000 in this transaction.

The client would receive $2,500 in refunds.

Note: if the non-licensed agent does not split the commission in the original listing, he would receive $8,000 in this transaction and his client would still receive $2,500 in refunds.

### Example 6

A client buys or sells a $150,000 house in which there is a 3% commission. The client does not originate a mortgage with Originator.

For a non-licensed agent, the total real estate commission would be $4,500 ($150,000×3%). The non-licensed agent would receive $3,000 from the proceeds of the real estate commission. Originator would receive $1,500 from the proceeds of the real estate commission.

The client would not receive any money back after closing from Originator.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

What is claimed is:

1. A method for real estate transactions concerning the purchase or sale of real property in association with a buyer, a realtor that receives a predetermined real estate commission for any sale consummated and a mortgage originator that receives a portion of the mortgage origination proceeds comprising the steps of:
(a) engaging the realtor to assist in the real estate transaction,
(b) engaging the mortgage originator to assist in the real estate transaction,
(c) providing unified communication among the buyer, the realtor and the mortgage originator,
(d) providing a simplified loan process for the buyer by the coordination between the realtor and the mortgage originator due to the unified communication among the buyer, the realtor and the mortgage originator,
(e) distributing to the buyer, from the real estate commission received by the realtor, a predetermined portion of money selected from the group consisting of the purchase price of the property and the loan amount, and
(f) distributing to the realtor a portion of the mortgage origination proceeds typically received by the mortgage originator to compensate for the portion of the purchase price of the property and loan amount distributed to the buyer from the real estate commission received by the realtor,
such that the buyer receives a predetermined portion of money from the purchase price of the property and the loan amount, the realtor receives the full amount of the predetermined real estate commission for the sale consummated and the mortgage originator receives a proportionately smaller portion of the mortgage origination proceeds.

2. A method for real estate transactions concerning the purchase or sale of real property in association with a client that can be a seller and a buyer, a realtor that receives a predetermined real estate commission for any sale consummated and a mortgage originator that receives a portion of the mortgage origination proceeds comprising the steps of:
(a) engaging the realtor to participate in the real estate transaction,
(b) engaging the mortgage originator to participate in the real estate transaction,
(c) providing unified communication among the client, the realtor and the mortgage originator, whereby the mortgage originator may be the realtor,
(d) providing a simplified loan process for the client by the coordination between the realtor and the mortgage originator due to the unified communication among the client, the realtor and the mortgage originator,
(e) upon the sale of property, distributing to the client, from the real estate commission received by the realtor, a predetermined portion of money selected from the group consisting of the purchase price, the loan amount and the listing fee, then
(f) distributing to the realtor a portion of the mortgage origination proceeds typically received by the mortgage originator to compensate for the portion of the purchase price, loan amount and listing fee distributed to the client from the real estate commission received by the realtor, and
(g) upon the purchase of property, distributing to the client, from the real estate commission received by the realtor, a predetermined portion of money selected from the group consisting of the purchase price, the loan amount and the listing fee, then
(h) distributing to the realtor a portion of the mortgage origination proceeds typically received by the mortgage originator to compensate for the portion of the purchase price, loan amount and listing fee distributed to the client from the real estate commission received by the realtor,
such that, upon a sale, a purchase, and any combination of sales and purchases, the client receives a predetermined portion of money from the purchase price of the property, the loan amount and the listing fee, the realtor receives the full amount of the predetermined real estate commission for the sale consummated and the mortgage originator receives a proportionately smaller portion of the mortgage origination proceeds.

3. A method for real estate transactions concerning the purchase or sale of real property in association with a client that can be a seller and a buyer, a realtor that receives a predetermined real estate commission for any sale consummated and a mortgage originator that receives a portion of the mortgage origination proceeds comprising the steps of:
(a) engaging the mortgage originator to assist in the real estate transaction such that the mortgage originator acts in the capacity of a loan officer and the realtor as well as the mortgage originator thereby eliminating the conventional use of the loan officer and the realtor,
(b) providing unified communication between the client and the mortgage originator such that the mortgage originator is guided to secure better mortgage terms for the client,
(c) providing a simplified loan process for the client because of the unified communication between the client and the mortgage originator,
(d) upon the sale of property, distributing to the client, from the real estate commission typically received by the realtor, a predetermined portion of money selected from the group consisting of the purchase price, the loan amount and the listing fee,
(e) upon the purchase of property, distributing to the client, from the real estate commission typically received by the realtor, a predetermined portion of money selected from the group consisting of the purchase price, the loan amount and the listing fee,
such that, upon the sale of property, the purchase of property, and any combination of sales and purchases, the client receives a predetermined portion of money from the purchase price of the property, the loan amount and the listing fee and the mortgage originator receives a proportionately smaller portion of the mortgage origination proceeds.

4. A system for conducting real estate transactions concerning the purchase or sale of real property in association with a client that can be a seller and a buyer, a realtor that receives a predetermined real estate commission for any sale consummated and a mortgage originator that receives a portion of the mortgage origination proceeds comprising:
(a) the realtor is engaged to assist in the real estate transaction,
(b) the mortgage originator is engaged to assist in the real estate transaction to the exclusion of the typical loan officer,
(c) the mortgage originator is in unified communication with the client and the realtor such that the mortgage originator is guided to secure better mortgage terms for the client,
(d) the unified communication between the client, the realtor, and the mortgage originator, without the loan officer, enhances the opportunity to achieve the best possible mortgage terms for the client,
(e) a simplified loan process for the buyer is created because of the unified communication between the client, the realtor, and the mortgage originator, without the loan officer,
(f) upon the sale of property, the client receives, from the real estate commission received by the realtor, a predetermined portion of money selected from the group consisting of the purchase price, the loan amount and the listing fee, then
(g) the realtor receives a portion of the mortgage origination proceeds typically received by the mortgage originator to compensate for the portion of the purchase price, loan amount and listing fee distributed to the client from the real estate commission received by the realtor, and
(h) upon the purchase of property, the client receives, from the real estate commission received by the realtor, a predetermined portion of money selected from the group consisting of the purchase price, the loan amount and the listing fee, then
(i) the realtor receives a portion of the mortgage origination proceeds typically received by the mortgage originator to compensate for the portion of the purchase price, loan amount and listing fee distributed to the client from the real estate commission received by the realtor,
such that, upon a sale, a purchase, and any combination of sales and purchases, the client receives a predetermined portion of money from the purchase price of the property, the loan amount and the listing fee, the realtor receives the full amount of the predetermined real estate commission for the sale consummated and the mortgage originator receives a proportionately smaller portion of the mortgage origination proceeds.

5. A system for conducting real estate transactions concerning the purchase or sale of real property in association with a client that can be a seller and a buyer, a realtor that receives a predetermined real estate commission for any sale consummated and a mortgage originator that receives a portion of the mortgage origination proceeds comprising:
(a) the mortgage originator is engaged to assist in the real estate transaction such that the mortgage originator acts in the capacity of a loan officer and the realtor as well as the mortgage originator thereby eliminating the conventional use of the loan officer and the realtor,
(b) the mortgage originator is in unified communication with the client such that the mortgage originator is guided to secure better mortgage terms for the client,
(c) the unified communication between the client and the mortgage originator, without the loan officer and the realtor, enhances the opportunity to achieve the best possible mortgage terms for the client,
(d) a simplified loan process for the buyer is created because of the unified communication between the client and the mortgage originator,
(e) upon the sale of property, the client receives, from the real estate commission typically received by the realtor, a predetermined portion of money selected from the group consisting of the purchase price, the loan amount and the listing fee,
(f) upon the purchase of property, the client receives, from the real estate commission typically received by the realtor, a predetermined portion of money selected from the group consisting of the purchase price, the loan amount and the listing fee,
such that, upon the sale of property, the purchase of property, and any combination of sales and purchases, the client receives a predetermined portion of money from the purchase price of the property, the loan amount and the listing fee and the mortgage originator receives a proportionately smaller portion of the mortgage origination proceeds.
